(19) United States
(12) Patent Application Publication
(10) Pub. No.: US 2018/0266270 A1
(43) Pub. Date: Sep. 20, 2018

(54) METHOD OF DETECTING FLAMEOUT IN A COMBUSTOR AND TURBINE SYSTEM

(71) Applicant: Nuovo Pignone Tecnologie Srl, Florence (IT)

(72) Inventors: Antonio ASTI, Florence (IT); Miriam LOSAPIO, Florence (IT); Mariateresa PACI, Florence (IT); Giovanni TONNO, Florence (IT)

(21) Appl. No.: 15/919,735

(22) Filed: Mar. 13, 2018

(30) Foreign Application Priority Data
Mar. 14, 2017 (IT) 102017000028052

(51) Int. Cl. F01D 21/00; F01D 21/16; F01D 21/14

(52) U.S. Cl. CPC F01D 21/003; F01D 21/16; F05D 2260/83; F05D 2220/32; F05D 2240/35; F01D 21/14

(57) ABSTRACT

The method allows to detect flameout in a combustor of a turbine system; it comprises the steps of: A) measuring angular acceleration of a shaft of the or each turbine of the turbine system, B) calculating a flameout indicator as a function of the angular acceleration, and C) carrying out a comparison between the flameout indicator and at least one threshold.

### TECHNICAL FIELD

Embodiments of the subject matter disclosed herein correspond to methods of detecting flameout in a combustor and to turbine systems.

### BACKGROUND ART

During operation of a turbine system a rare event called “flameout” may occur; “flameout” means that the flame of the combustor of the turbine system completely extinguishes.

Flameout is a very dangerous event; therefore, it should be detected as soon as it occurs and possibly corrective measures should be taken.

According to the prior art, at least one flame detector is located just inside the combustion chamber of the combustor of the turbine system.

Such flame detectors are designed to sense directly the presence of a flame so they are able to provide a very short response time.

Such flame detectors are subject to very hard operating conditions; this creates problems both from the construction and the operation point of view.

It would be desirable to improve the prior art.

### SUMMARY

Therefore, the Inventors have thought of indirectly sensing the presence of the flame, in particular through operating parameters of the turbine system.

Embodiments of the subject matter disclosed herein relate to methods of detecting flameout in a combustor of a turbine system.

According to such embodiments, the method comprises the steps of: A) measuring angular acceleration of a shaft of a turbine of the system, B) calculating a flameout indicator as a function of the angular acceleration, and carrying out a comparison between the flameout indicator and a threshold.

Preferably, the flameout indicator is calculated also as a function of a pressure measured at an outlet of a compressor of the system, and of a thermal power generated by a combustor of the system.

Other embodiments of the subject matter disclosed herein relate to turbine systems.

According to such embodiments, the turbine system comprises a compressor, a combustor downstream of the compressor, a turbine downstream of the combustor, an angular acceleration detector associated to a shaft of said turbine, and a digital signal processing unit adapted to carry out a flameout detection method.

Preferably, the turbine system further comprises: a pressure detector associated to an outlet of the compressor, a temperature detector associated to an outlet of the turbine or another turbine, and an angular speed detector associated to a shaft of the turbine or another turbine.

It is to be noted that the present invention has been conceived for application in the field of “Oil & Gas”.

### BRIEF DESCRIPTION OF DRAWINGS

The accompanying drawings, which are incorporated herein and constitute an integral part of the present specification, illustrate exemplary embodiments of the present invention and, together with the detailed description, explain these embodiments. In the drawings:

FIG. 1 shows a schematic diagram of a turbine system using a flameout detection method according to the subject matter disclosed herein, and

FIG. 2 shows a flowchart of an embodiment of a flameout detection method according to the subject matter disclosed herein.

### DETAILED DESCRIPTION

The following description of exemplary embodiments refers to the accompanying drawings.

The following description does not limit the invention. Instead, the scope of the invention is defined by the appended claims.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

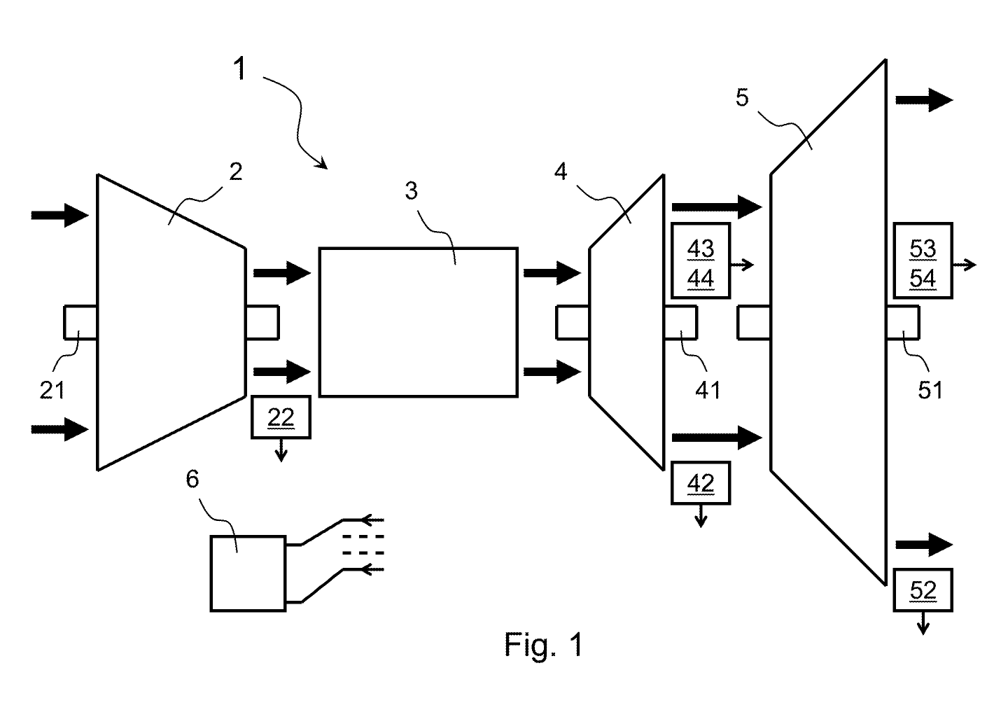

FIG. 1 shows a turbine system 1 comprising: a compressor 2, a combustor 3, a first turbine 4 (that may be called “high-pressure turbine”), a second turbine 5 (that may be called “low-pressure turbine”), and a digital signal processing unit 6. Compressor 2 has an own shaft 21; the first turbine 4 has an own shaft 41; the second turbine 5 has an own shaft 51 (mechanically disconnected from shaft 41). An outlet of compressor 2 is fluidly connected to an inlet of combustor 3; an outlet of combustor 3 is fluidly connected to an inlet of turbine 4; an outlet of turbine 4 is fluidly connected to an inlet of turbine 5. It is to be noted that combustor 3 has at least another inlet (not shown in FIG. 1), for example a fuel inlet.

Furthermore, turbine system 1 comprises: a pressure detector 22 measuring pressure, for example the average pressure, at the outlet of compressor 2 (corresponding substantially to the inlet of combustor 3), a temperature detector 42 measuring temperature, for example the average temperature, at the outlet of turbine 4 (corresponding substantially to the inlet of turbine 5), a temperature detector 52 measuring temperature, for example the average temperature, at the outlet of turbine 5, an angular speed detector 43 measuring angular speed of shaft 41, an angular acceleration detector 44 measuring acceleration speed of shaft 41, an angular speed detector 53 measuring angular speed of shaft 51, an angular acceleration detector 54 measuring acceleration speed of shaft 51.

According to a typical embodiment, combustor 3 comprises a plurality of burners arranged annularly.

According to embodiments alternative to the one of FIG. 1, the turbine system may comprise more than one compressor (for example serially connected) and/or one or two or three or more turbines (for example serially connected).

Digital signal processing unit 6 is electrically connected to detectors 22, 42, 43, 44, 52, 53, 54 and receives measure signals from these detectors.

In order to detect flameout of combustor 3, the following steps may be carried out:
A) measuring angular acceleration of a shaft of a turbine,
B) calculating a flameout indicator as a function of the angular acceleration, and
C) carrying out a comparison between the flameout indicator and a threshold.

Considering turbine system 1 of FIG. 1, at step A, it is possible 1) to measure only acceleration of shaft 41 or 2) to measure only acceleration of shaft 51 or 3) to measure both accelerations and then, at step B, to use e.g. the product of both accelerations for calculating the flameout indicator. In fact, if the or each turbine downstream the combustor decelerates quickly, it is likely that flameout occurs.

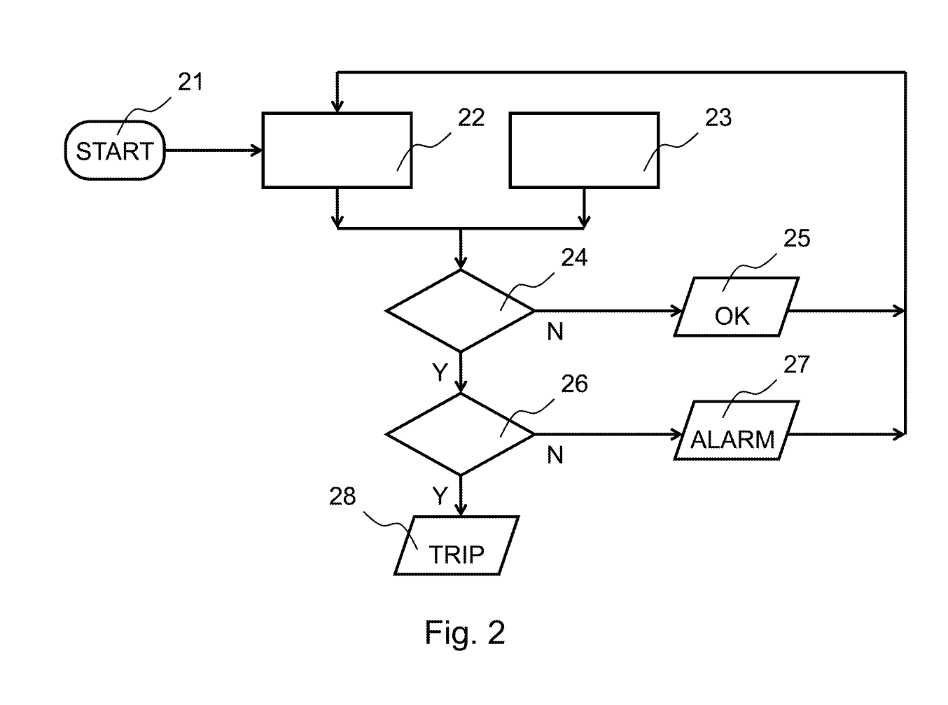

In the flowchart of FIG. 2, there is a block 21 corresponding to a START and a block 22 corresponding to steps A and B.

The threshold at step B is typically fixed and may be predetermined or variable. If the threshold is variable, it may depend on a current load state of the turbine system 1; in FIG. 2, block 23 corresponds to a pre-calculation of one or more thresholds based on measured operating parameters of the turbine system 1; for this purpose, “load state of a turbine system” may be considered the power generated by the turbine system. According to some embodiments, it has been experimentally determined that one fixed and predetermined value of 0.2 is adequate for the threshold across an entire load range.

In the flowchart of FIG. 2, two different thresholds (i.e. threshold-1 and threshold-2) are used (see block 24 and block 26); in particular, the first threshold is lower than the second threshold (i.e. threshold-1<threshold-2). For most applications of the present invention, a single threshold is sufficient as it will be explained in the following.

In the flowchart of FIG. 2, block 24 corresponds to a comparison of the calculated flameout indicator with a first threshold (i.e. “is indicator>threshold-1?”) and block 26 corresponds to a comparison of the calculated flameout indicator with a second threshold (i.e. “is indicator>threshold-2?”). A negative result N at block 24 indicates that combustor 3 is far from “flameout” and, subsequently to step C, “OK” is signaled at block 25; for example, digital signal processing unit 6 may send an ok signal to a remote monitoring unit or send no signal at all. A positive result Y at block 24 may indicate that combustor 3 is either close to “flameout” or at “flameout”. A negative result N at block 26 indicates that combustor 3 is close to “flameout” and, subsequently to step C, “ALARM” is signaled at block 27 (that may correspond to a step D); for example, digital signal processing unit 6 may send an alarm signal to a remote monitoring unit. A positive result Y at block 26 indicates that combustor 3 is at “flameout” and, subsequently to step C, “TRIP” of turbine system 1 (i.e. switching-off) is carried at block 28 (that may correspond to a step D).

After blocks 25 and 27, the flow returns to block 22. This means that the “flameout indicator” is calculated repeatedly, in particular periodically; more precisely, at least steps A, B and C are cyclically repeated in time. The average repetition period may be in the range from e.g. 10 mS to e.g. 1000 mS.

It is to be noted that, according to a flowchart alternative to the one of FIG. 2, blocks 26 and 27 are not present, i.e. there is only one threshold, the turbine system is either considered “OK” or at “flameout”, and at “flameout” the turbine system is simply switched-off.

It is to be noted that, according to a flowchart alternative to the one of FIG. 2, block 26 is not present and block 25 is located immediately before or after block 27, i.e. there is only one threshold, the turbine system is either considered “OK” or at “flameout”, and at “flameout” an alarm is signaled and the turbine system is switched-off.

According to the embodiments just described, as soon as a threshold is reached an action is taken.

Alternatively, it may be provided that an action is taken only after a predetermined time or after a predetermined number of “consecutive positive results”. For example referring to FIG. 2, if the average repetition period is 20 mS, it may be provided that “ALARM” is signaled after e.g. 1 or 2 consecutive positive results from the comparison at block 24 (corresponding approximately to 20 or 40 mS) and/or that “TRIP” occurs after e.g. 4 or 5 consecutive positive results from the comparison at block 26 (corresponding approximately to 80 or 100 mS). This means, in particular, that TRIP is decided only if deceleration proceeds for some (short) time.

A formula that may be used at step B is the following:

−A*Pth/p

wherein “A” is an acceleration, “p” is a pressure and “Pth” is a “thermal power”.

As already explained, “A” may be the measured angular acceleration of the shaft of the first turbine or the measured angular acceleration of the shaft of the second/last turbine or the product of these angular accelerations, i.e. A1 or A2 or A1*A2.

“p” may be a pressure measured at an outlet of a compressor of the turbine system; referring to FIG. 2, it may be the average pressure measured at the outlet of compressor 2. This parameter is used to take into account any effect on the combustor due to any reduction of oxidant pressure (typically air pressure) provided to the combustor.

“Pth” is a parameter related to the thermal power generated by the combustor and is used to take into account any deceleration of the or each turbine which is desired or normal; for this purpose, “thermal power generated by a combustor” may be considered the fuel flow rate multiplied by its calorific value. For example, the or each turbine decelerates in case of “load rejection” or “full load rejection”.

Preferably, “Pth” is the thermal power generated by the combustor calculated based on operating parameters of the turbine system.

More preferably, “Pth” is calculated as a function of an angular speed, a temperature, and optionally another angular speed. Referring to FIG. 1, the angular speed is measured at shaft 41 of turbine 4, the temperature is measured at an outlet of turbine 4 or, preferably, turbine 5, the other angular speed is measured at shaft 51 of turbine 5.

The formula ‘A*Pth/p allows a very precise estimation of “flameout”.

The flameout detection method according to the subject matter disclosed herein may be used in a turbine system like the one of FIG. 1 or in a system similar thereto.

The turbine system should comprise a digital signal processing unit adapted to carry out such flameout detection method; such unit typically comprises a software program for this purpose. In the embodiment of FIG. 1, such unit is labelled 6.

In order to carry out a flameout detection method, at least one detector is necessary, i.e. at least an angular acceleration detector (with reference to FIG. 1, detector 44 and/or detector 54); preferably, at least at least one angular accelerator detector (with reference to FIG. 1, detector 44 and/or detector 54) and at least one pressure detector (with reference to FIG. 1, detector 22) are used; more preferably, several detectors are used (with reference to FIG. 1, detectors 22, 42, 43, 44, 52, 53, 54).

The flameout detection method according to the subject matter disclosed herein allows to reliably and precisely and quickly detect flameout without any flame detector located just inside the combustion chamber of the combustor. In any case, the detection result from a flame detector may be used as a further safety measure.

The flameout detection method according to the subject matter disclosed herein allows to reliably and precisely and quickly detect flameout through the use of components (in particular sensors/detectors) that are normally already present in the turbine system for other purposes.

It is to be noted that a detection arrangement according to the subject matter disclosed herein may be specialised for a particular model of turbine system and/or may be calibrated before its use in an installed sample of turbine system. One parameter that requires particular care is the value of the or each threshold.

What we claim is:

1. A method of detecting flameout in a combustor of a turbine system, wherein the turbine system comprises a compressor upstream said combustor and a turbine downstream said combustor, the method comprising the steps of:
A) measuring angular acceleration of a shaft of said turbine,
B) calculating a flameout indicator as a function of said angular acceleration, and
C) carrying out a comparison between said flameout indicator and a threshold.

2. The method of claim 1, a positive result of said comparison indicates flameout.

3. The method of claim 1, wherein steps A, B and C are cyclically repeated in time, and wherein a set of consecutive positive results of said comparison indicates flameout.

4. The method of claim 1, said threshold depends on a load state of the turbine system.

5. The method of claim 1, comprising a step D of signaling an alarm, to be carried after step C.

6. The method of claim 5, wherein at step C a first threshold is used.

7. The method of claim 1, comprising a step E of tripping said turbine system, to be carried after step C or step D.

8. The method of claim 7, wherein at step C a second threshold is used.

9. The method of claim 1, wherein at step A another angular acceleration of a shaft of another turbine downstream of said turbine is measured, wherein at step B said flameout indicator is calculated also as a function of said another acceleration.

10. The method of claim 1, wherein at step B said flameout indicator is calculated also as a function of a pressure measured at an outlet of said compressor.

11. The method of claim 1, wherein at step B said flameout indicator is calculated also as a function of a thermal power generated by said combustor.

12. The method of claim 11, wherein said thermal power is calculated as a function of an angular speed, a temperature, and optionally another angular speed, wherein said angular speed is measured at a shaft of said turbine, wherein said temperature is measured at an outlet of said turbine or said another turbine downstream of said turbine, wherein said another angular speed is measured at a shaft of another turbine downstream of said turbine.

13. The method of claim 9, wherein at step B said flameout indicator is calculated according to the formula:
−A1*Pth/p
or the formula:
−A2*Pth/p
or the formula:
−A1*A2*Pth/p
wherein A1 is the measured angular acceleration of the shaft of the turbine, A2 is the measured acceleration of the shaft of another turbine, Pth is the calculated thermal power generated by the combustor, p is the pressure measured at an outlet of the compressor.

14. A turbine system comprising a compressor, a combustor downstream of said compressor, a turbine downstream of said combustor; and further comprising:
an angular acceleration detector associated to a shaft of said turbine,
and
a digital signal processing unit adapted to carry out the method according to claim 1.

15. The turbine system of claim 14, further comprising:
a pressure detector associated to an outlet of said compressor,
a temperature detector associated to an outlet of said turbine or another turbine,
and
an angular speed detector associated to a shaft of said turbine or another turbine.
